(19) United States
(12) Patent Application Publication
(10) Pub. No.: US 2024/0267663 A1
(43) Pub. Date: Aug. 8, 2024

(54) SMART WIRELESS CAMERA EARPHONES

(71) Applicant: Raul Garcia Martin, Tres Cantos (ES)

(72) Inventor: Raul Garcia Martin, Tres Cantos (ES)

(21) Appl. No.: 18/164,440

(22) Filed: Feb. 3, 2023

(51) Int. Cl. H04R 1/10

(52) U.S. Cl. CPC H04R 1/1016; H04R 1/1008; H04R 1/1091; H04R 2201/107; H04R 2420/07

(57) ABSTRACT

A wireless, in-ear, or non-in-ear, earphone comprising a microphone, a speaker, and a camera module in the earbud casing, the camera module is configured to obtain images of the user's environment, the camera module comprising a near-infrared camera to capture the images using a near-infrared LED. The earphone comprises an internal microcontroller configured to obtain information extracted from processing the captured images. Image processing applies computer vision and can be executed by the microcontroller of the earphone and/or a guest device with which the microcontroller is communicated through a wireless communication interface by means of an on-chip antenna. The earphone further comprises a short-range wireless communication module to receive audio information and to play the received audio in the speaker.

### BACKGROUND

The present invention generally relates to the consumer electronics industry and, more particularly, to wireless earphones.

In-ear/earbud wireless headphones/earphones have been massively used since their commercial Bluetooth launch in the 2010s. Commonly, they can be classified according to the ear fit into over-ear headphones: they typically have thick headbands and large ear cups that fully encompass the ears; on-ear headphones: with smaller ear cups that rest on the ears and also with slightly less bass, usually more compact than over-ear designs; earbuds: small, ultra-portable earphones with earbud tips, that rest at the edge of the ear canal; and in-ear earphones: ultra-portable with small earbud tips, which are inserted into the ear canal. And all of them use the wireless Bluetooth communication protocol.

There are existing spying devices comprising over-ear headphones or in-ear earphones, which include a camera. The spying over-ear headphones camera can record video and audio with Wi-Fi enabled. The camera of the existing in-ear earphones is not an IP camera (Internet Protocol camera), cannot provide audio information, and the earphones are not wireless because they are specifically designed to spy, just to allow the user to look like a person listening to music while the camera is video recording. A non-in-ear earphone version with a bluetooth camera is also known but the camera is facing the ear canal and so it cannot be used for spying, and the earphone loses the audio capability as in the aforementioned in-ear earphones.

Therefore, there is a need to provide a pair of earphones with video recording means that also provide real-time audible information to the user about the surrounding environment apart from the desired user audio.

### SUMMARY

The problems found in prior art techniques are generally solved or circumvented, and technical advantages are generally achieved by the disclosed embodiments, which provide earphones with a plurality of intelligent wireless cameras (preferably two cameras: one per earphone) which provide real-time audible data about the user's surrounding environment and wherein the provided data includes:
Three-dimensional (3D) information by combining the video frames captured by the camera(s) of each of the two (left and right) earphones.
Night vision from each of the cameras combined with an infrared (IR) light (e.g., provided by an IR-LED source mounted in each earphone) so that they can capture infrared radiation under poor-quality lighting conditions.
Artificial Intelligence (AI) knowledge: video frames are captured by the wireless cameras and processed in real time by the intelligent earphones and/or by an external processing (guest) device (e.g., smartphone, tablet, laptop, desktop computer, and any embedded system) to obtain advanced information for the user provided by the intelligent earphones and/or the guest device using Computer Vision (CV) techniques.

The obtained information is related to the user's environment; i.e., data about the surroundings in which the user wearing the earphones operates them. The CV techniques allow, among other applications, the detection of objects, the detection of environmental conditions (e.g., a dangerous situation for the user detected from the images of his/her environment) and generation of 3D information.

Since all the data provided by the proposed intelligent wireless camera (in-ear or non-in-ear) earphones can be processed on external processing devices, the earphones can be combined with other smart wearable devices or gadgets (e.g., VR/AR goggles). Therefore, the present invention also has applications in systems handling with Virtual Reality (VR), Augmented Reality (AR), Mixed Reality (MR), Extended Reality (XR), and metaverse environments.

An aspect of the present invention refers to a wireless earphone that comprises:
an earbud casing, designed for an in-ear or a non-in-ear earphone configuration;
a camera module located in the earbud casing, the camera module being configured to obtain images captured by at least one near-infrared camera and using at least one near-infrared light source, being incorporated into the earbud casing;
a microcontroller located in the earbud casing, the microcontroller being configured to obtain information extracted from the captured images using computer vision, and the microcontroller being communicated with at least one on-chip antenna located in the earbud casing to provide a Wi-Fi communication interface (or other wireless network protocol), and the microcontroller being further configured to send the captured images in real-time through the Wi-Fi communication interface;
a microphone and a speaker;
a Bluetooth (or any other short-range wireless interface) module located in the earbud casing, configured to receive audio information and to play the received audio in the speaker.

The earphones device in accordance with the above-described aspects of the invention, has a number of advantages with respect to the aforementioned prior art, which can be summarized as follows:
The present invention can provide new extra information to users, and so, although it is not the final goal, it can improve the existing spy devices.
Two (or more) cameras are used, at least one per headphone/earphone, in a wireless way.
The plurality of cameras is synchronized so that they can provide 3D real-time environmental information by combining their captured video frames, which can be applied in object recognition and object tracking, running Artificial Intelligence models on the headphones/earphones or externally on a server.
This 3D information, provided in audio format, is helpful for most users, especially for visually disabled people.
Night vision capabilities provided by the cameras along with the near-infrared LEDs mounted in each earphone to capture near-infrared light, allow extracting information from the recorded images captured under low-light conditions.
Both the in-ear and non-in-ear earphones configuration include at least one camera per earphone, preserving the audio/calls capabilities.
The proposed earphones can play real-time information/warning audio messages, music, and calls as conventional earphones, while the cameras of the earphones are taking pictures, recording videos or capturing images in real-time. For this purpose, a microphone is included in the mounted electronics of the earphones.
Real-time image processing is provided by integrating an image processing processor into the earphones device itself or by an external guest device (i.e., smartphones, tablets, laptops, desktop computers, and embedded systems) connected with the proposed earphones by using Wi-Fi. Furthermore, IEEE 802.11 Wi-Fi communication can be used to provide not only external computer/server frame processing but also extra information to Augmented/Virtual Reality wearable devices, such as AR/VR goggles.
For AR/VR/XR applications, the invention can help to reduce the number of cameras in heavy and oversized AR/VR headsets by replacing some of them (e.g., the hand tracking or the stereo 3D map can be performed by the near-infrared stereo pair included in the invention). Furthermore, the invention improves the immersive experience by playing extra audible information such as warning messages (e.g., car/object approaching the user too fast) or advising messages/music (e.g., video games) and increases the field of view of the AR/VR goggles.

### BRIEF DESCRIPTION OF THE DRAWINGS

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

To complete the description that is being made and with the object of assisting in a better understanding of the characteristics of the invention, in accordance with a preferred example of a practical embodiment thereof, accompanying said description as an integral part thereof, is a set of drawings wherein, by way of illustration and not restrictively, the following has been represented:

FIG. 1 shows a view of a pair of in-ear wireless earphones, according to a possible embodiment of the present invention.

FIG. 2 shows a view of a pair of non-in-ear wireless earphones, according to another possible embodiment of the present invention.

FIG. 3 shows a block diagram of the electronic architecture of the earphones for both in-guest image processing and in-system image processing configuration.

FIG. 4 shows the flowchart of the working procedure for the earphone according to a possible in-guest configuration.

FIG. 5 shows the flowchart of the working procedure for the earphone according to a possible in-system configuration.

FIG. 6 shows a workflow of the earphone combined with an external guest device for audio processing information, according to the in-guest configuration.

FIG. 7 shows a workflow of the camera in the earphone combined with the external guest device, according to the in-guest configuration.

FIG. 8 shows a step for processing the images captured by the camera in the earphone, according to the in-guest configuration.

FIG. 9 shows a step for processing the images captured by the camera in the earphone, according to the in-system configuration.

FIG. 10 shows a step for playing an audible interruption voice message by the earphone according to the in-guest configuration.

FIG. 11 shows a step for playing an audible interruption voice message by the earphone according to the in-system configuration.

FIG. 12 shows a workflow of the earphone combined with an AR/VR/XR headset as a guest device, according to the in-guest configuration.

FIGS. 13A-13C show how the invention increases the field of view of a pair of AR/VR/XR goggles.

### DETAILED DESCRIPTION

The present invention may be embodied in other specific systems and/or methods. Therefore, the described embodiments are to be considered in all respects as only illustrative and not restrictive. A description of example embodiments follows.

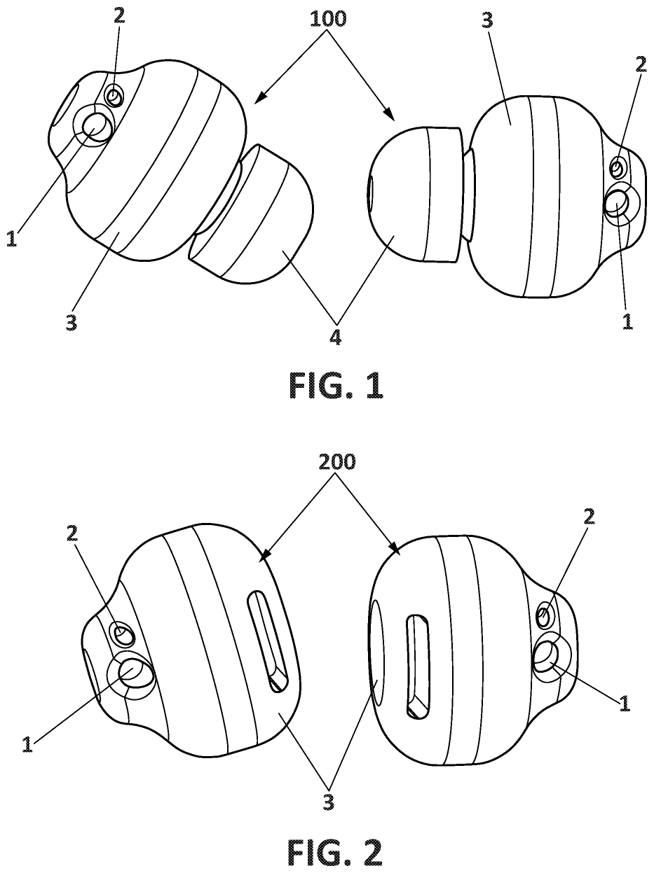

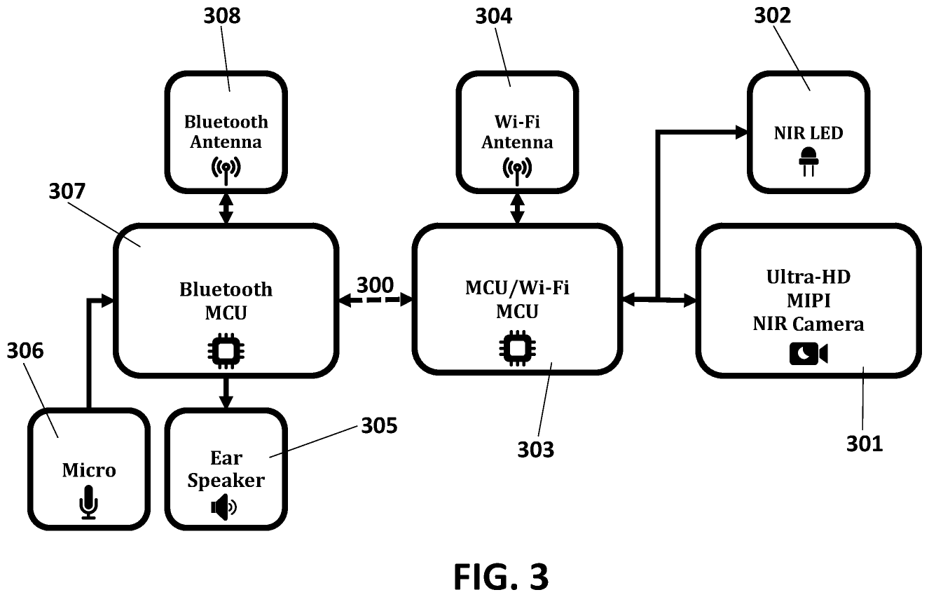

FIG. 1 shows a view extracted from a three-dimensional (3D) design of a pair (for left and right ears) of in-ear wireless earphones 100, comprising at least one near-infrared camera 1 and at least one near-infrared light source 2 (e.g., a near-infrared Light Emitting Diode, LED), both integrated into the earbud casing 3 and an ear speaker casing 4. FIG. 2 shows a view extracted from another 3D design of, left and right, wireless earphones 200, which are not in-ear;

e.g., bone-conduction headphones that rest on the listener's cheekbones or temples, and so, since these headphones produce their sound via vibrations, the not in-ear earphones do not have visible speakers but wireless invisible bone sensor vibrators (not shown in FIG. 2).

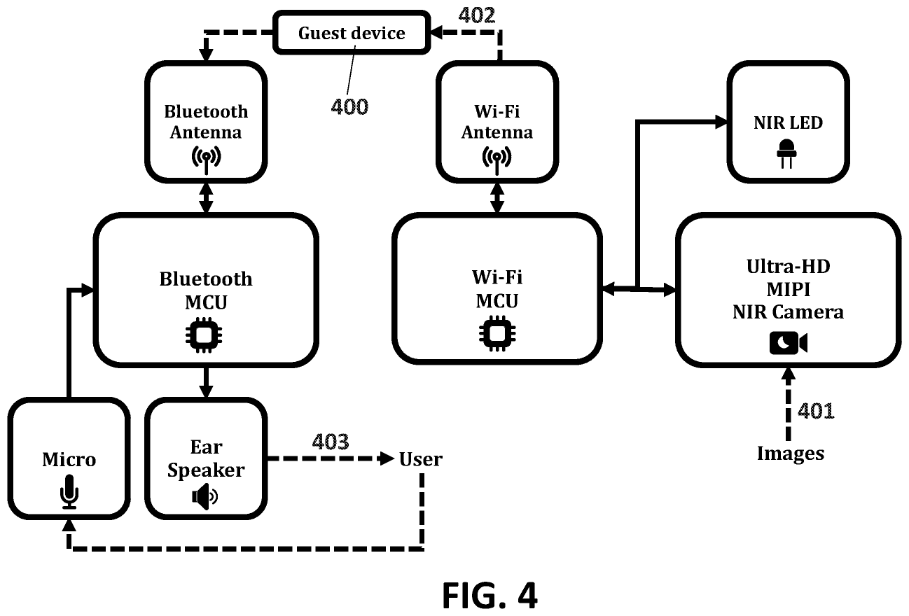

The electronics of each earphone for both types (in-ear or not in-ear) wireless earphones 100, 200 (and for left and right ears) comprises the following components, shown in FIG. 3:
A camera module 301, which is an Ultra-Height-Definition (UHD) Mobile Industry Processor Interface (MIPI®) camera module configured to process images captured by the near-infrared camera 1 for proper performance even at night if a near-infrared blocking is not assembled. The UHD MIPI camera can capture images in autofocus mode by using its voice coil motor at 30 and 60 FPS (Frames Per Second).
A near-infrared LED 302 is included as the near-infrared light source 2 to illuminate the scene in a continuous or pulsed way if the MIPI camera module 301 is set up as a near-infrared camera 1.
A microcontroller configured to obtain information based on the captured images and being communicated to at least one on-chip antenna, the microcontroller which at least comprises a microcontroller unit 303 with a wireless communication interface, e.g., a dedicated IEEE 802.11 Wi-Fi low-power Microcontroller Unit (MCU) operating at 2.4 or 5 GHZ, configured to send in real time the images from the camera 1 to the desired Local Area Network (LAN) guest, i.e., a Wi-Fi network.
An on-chip antenna 304 connected to the Wi-Fi microcontroller unit 303 for sending images in real time via Wi-Fi communication.
A tiny speaker 305.
A tiny microphone 306.
A Bluetooth microcontroller unit 307, e.g., a dedicated IEEE 802.15 Bluetooth Classic or Low Energy (BLE) MCU operating at 2.4 GHz configured to play audible information/music in the speaker.
A Bluetooth on-chip antenna 308 connected to the previous BLE MCU for the Bluetooth communication.

Instead of Bluetooth protocols, another short-range wireless technology standard can be used.

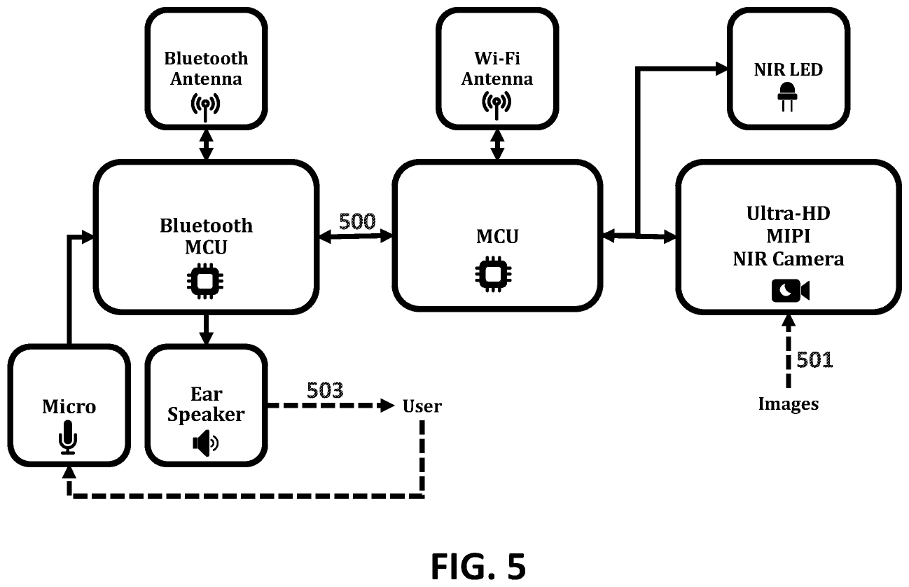

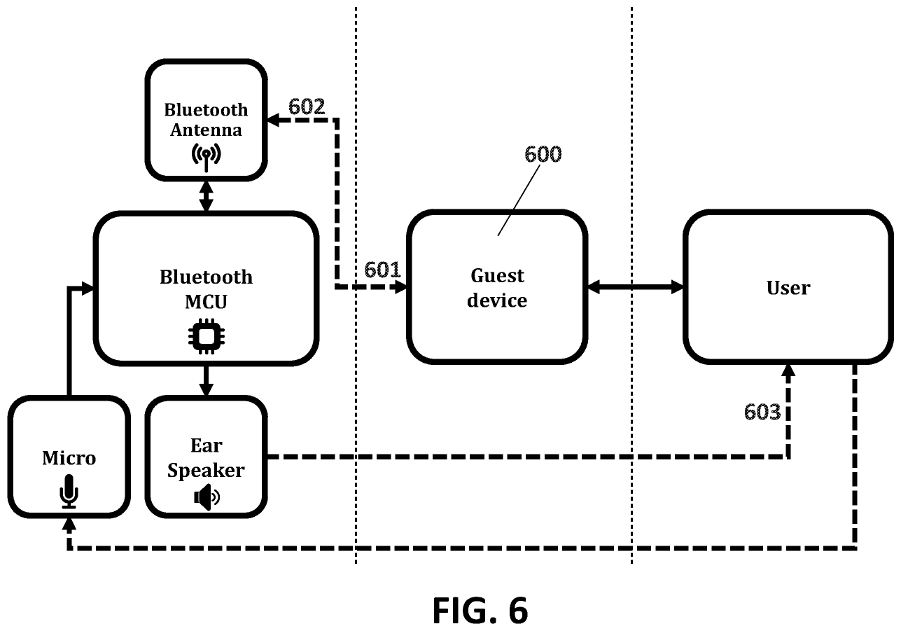

Two different configurations of the main microcontroller unit 303, shown in FIG. 3, are proposed according to the desired performance:
a) In a possible embodiment of the invention, an in-guest image processing configuration is defined and FIG. 4 shows the flowchart of the working procedure for each earphone: The pair of earphones works in combination with a guest external processing device, which can be a smartphone, a smart speaker, an intelligent assistant, a tablet, a personal/desktop computer, a laptop, a TV set, a wearable programmable device or an embedded system. The captured images 401 are processed by a Wi-Fi microcontroller unit located in the guest external processing device 400 and connected to the Wi-Fi MCU of each earphone through its Wi-Fi antenna. The guest device 400 receives 402 images in real time via Wi-Fi. The audible information required by the user 403, including the audible information extracted from the information obtained by the guest external processing device 400 is sent 404 to the proposed earphones via Bluetooth. In this way, the processing load is distributed to the guest device 400.
b) In another possible embodiment of the invention, an in-system image processing configuration is defined and each earphone works according to the flowchart of FIG. 5: The camera images 501 are processed in the main MCU, which is in charge of managing the Wi-Fi communication internally 300, 500 or by means of an external Wi-Fi MCU. The information for the user 503 is received directly/internally by the Bluetooth MCU of the earphone.

Both configurations allow for reducing the electronic size, not only by including the proposed electronics of a listening system in headphones but also in in-ear and non-in-ear earphones. In addition, to further reduce the size of the electronics, both Wi-Fi and Bluetooth communications in both configurations can be performed via a single multicore microcontroller, multiplexing both protocols onto a single antenna.

Each (in-ear or non-in-ear) earphone includes small batteries that can be recharged by a wireless charger similar to the ones already used in the current headphones and other wearable devices, such as smartwatches.

An advanced enclosure design of the earbud casing fits the user's ear, providing correct electronic thermal dissipation and electronic protection against electromagnetic radiation, dust, and water, making the earphones suitable for use underwater.

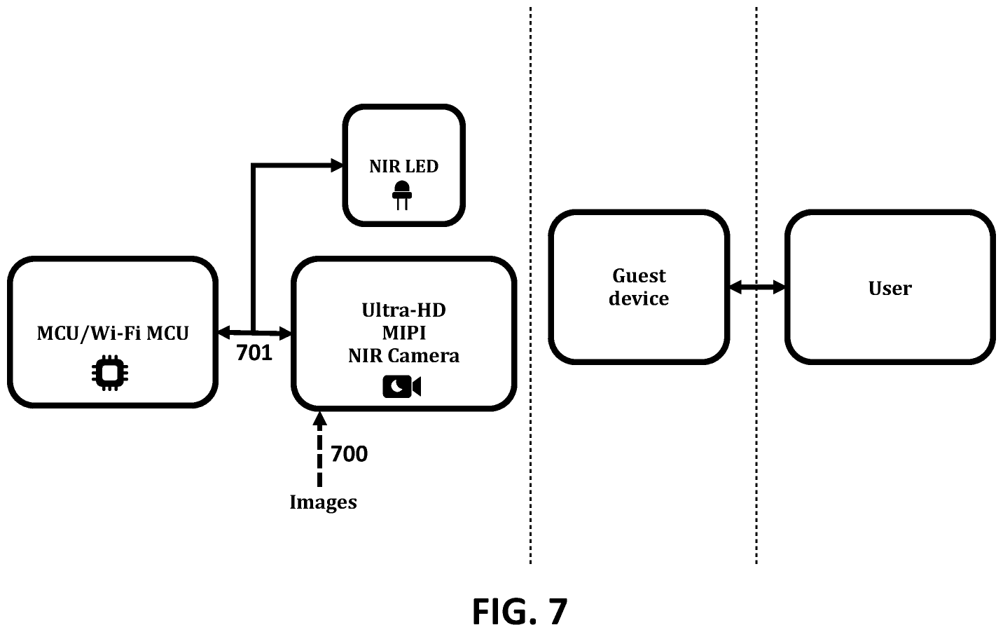

In a possible use case, the user plays audio/music/calls in the earphones according to the working procedure, which is divided into four steps and described as follows, summarized in FIGS. 6-11.

FIG. 6 shows a guest device 600 (e.g., a smartphone tablet, laptop, computer, embedded system) of the user, the (external) guest device 600 in charge of external processing images and sending audio information 601 via Bluetooth. The (internal) Bluetooth module, comprising the Bluetooth MCU and the Bluetooth antenna, receives audio information 602 from the external guest device 600 and plays 603 it by means of the ear speaker for the audio/music/call application. This process is run continuously, and the workflow follows the opposite way with the microphone of the earphone simultaneously.

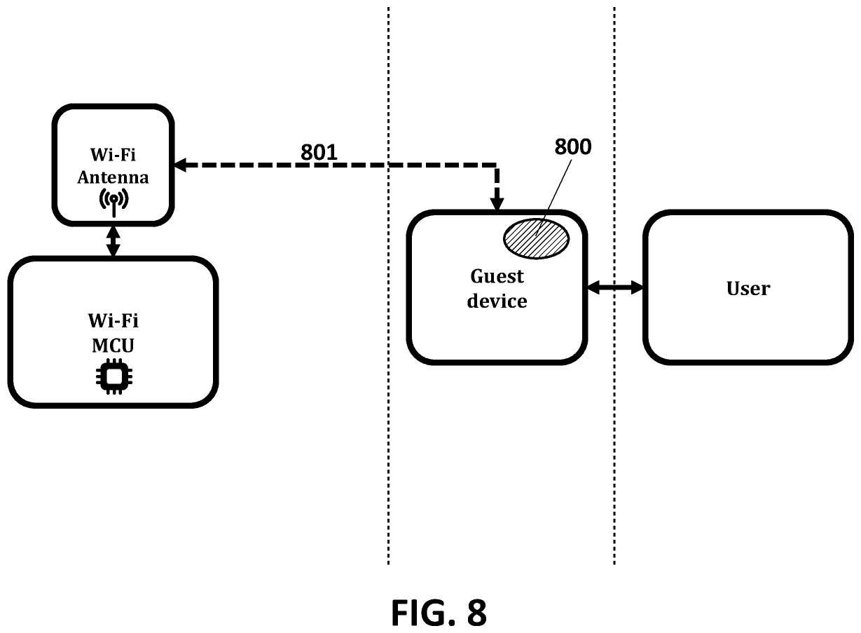

At the same time, while the user is playing audio/music/calls, as shown in FIG. 7, the two synchronized UHD near-infrared cameras (one per earphone) capture 700 real-time images that the microcontroller (MCU/Wi-Fi MCU) receives 701. This process is run continuously. Images are processed by the (external or internal) microcontroller unit using Computer Vision (CV) to, among other applications, detect objects, generate 3D information, and detect environmental situations (e.g., a car approaching the user too fast). The near-infrared LEDs are powered on if low light conditions are detected.

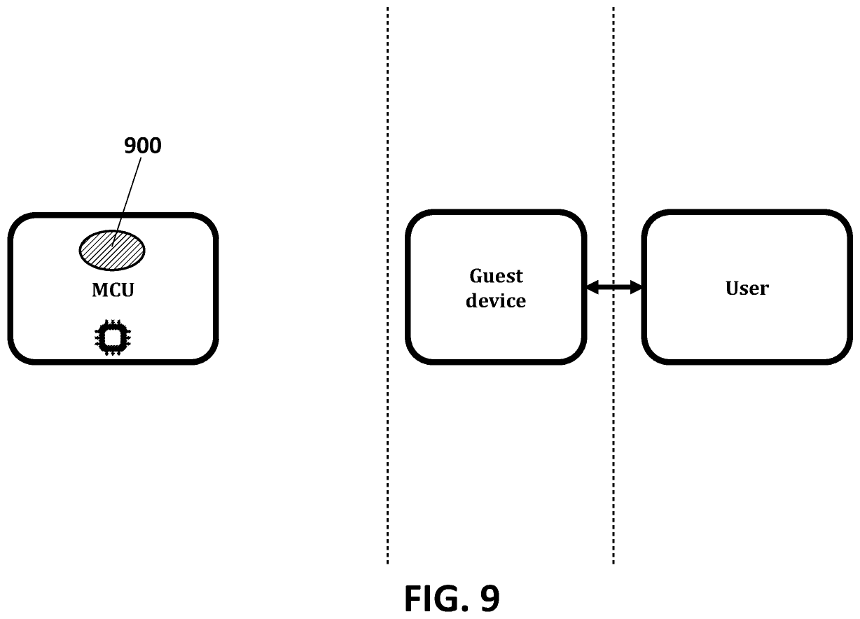

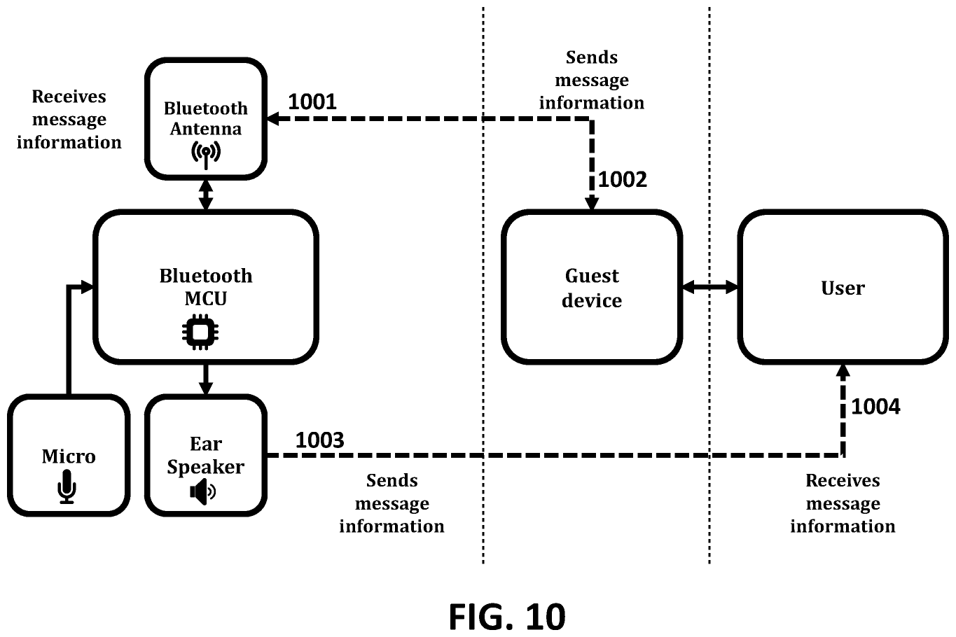

The step for processing the images captured by each camera can be performed in any of two different ways, according to a possible example: in-guest configuration shown in FIG. 8 or in-system shown in FIG. 9. Following the in-guest configuration, shown in FIG. 8, the image processing step 800 is run continuously on the external guest device to which the images are sent 801 from the Wi-Fi module, comprising the Wi-Fi MCU and the Wi-Fi antenna, via Wi-Fi protocol. Following the in-system configuration, shown in FIG. 9, the processing step 900 of the camera images is run continuously in the main internal microcontroller (MCU) of the earphone containing the corresponding camera.

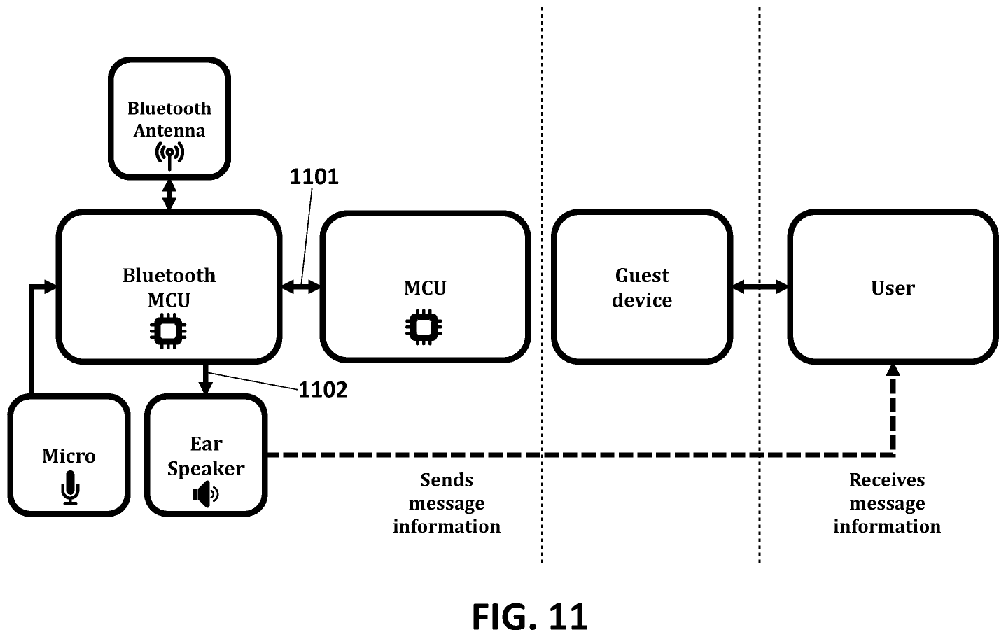

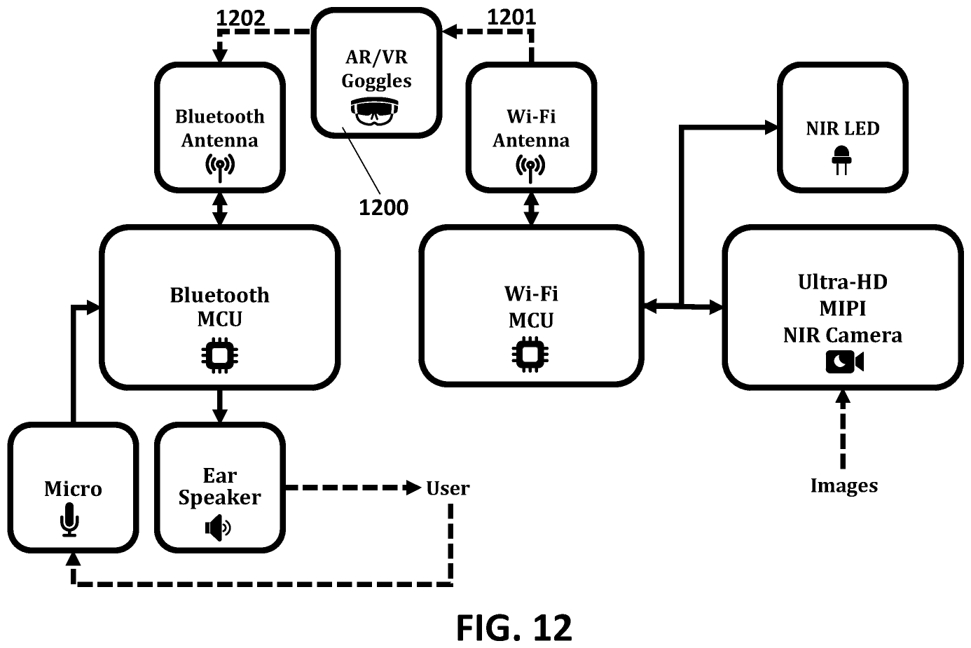

According to the information priority, the speakers can receive and play an audible interruption voice message informing, advising, or warning the user, as shown in the examples of FIGS. 10-11. Following the in-guest configuration, shown in FIG. 10, the processed information related to the audible interruption is received 1001 by the Bluetooth module (Bluetooth MCU and Bluetooth antenna) from the external guest device, which sends 1002 the interruption message via Wi-Fi and, in turn, the Bluetooth MCU sends 1003 the interruption information through the ear speaker to the user, who receives 1004 an audible interruption voice message according to a defined priority. Following the in-system configuration, shown in FIG. 11, the Bluetooth MCU 1101 receives the processed information for interruption from the main MCU, and the received information interruption is then played 1102 in the ear speaker of the user, who receives the information as an interruption above the audio/music/calls according to the defined priority. This process, in in-guest configuration or in-system configuration, is run continuously.

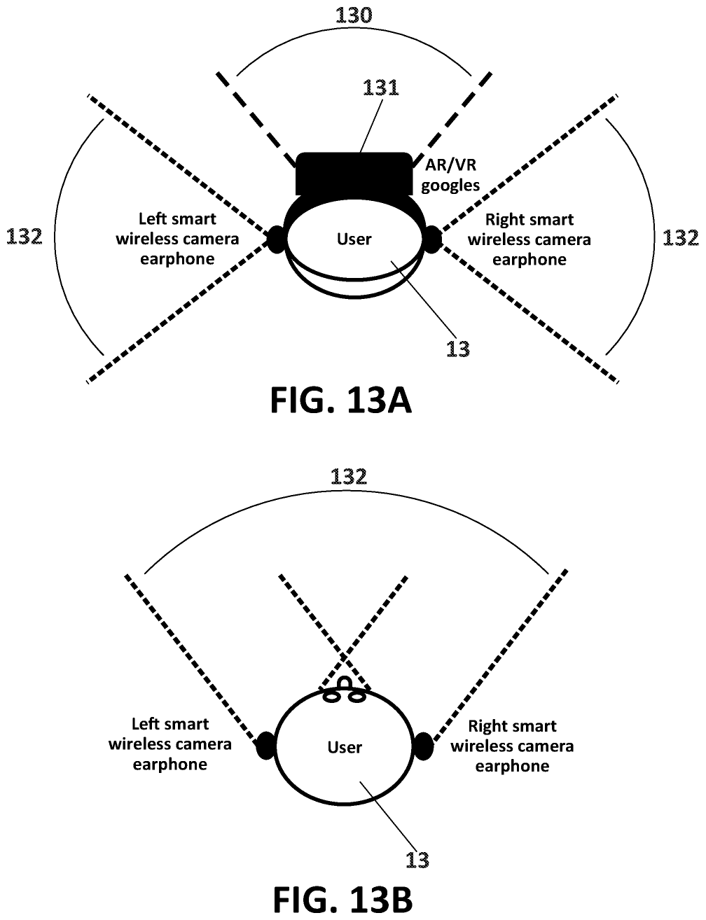

Another possible use case is to combine the proposed earphones with an external guest device which is an AR/VR/XR headset 1200, as shown in the workflow of FIG. 12, following the in-guest configuration. Thus, the proposed earphones are not only useful for all the technical solutions previously enumerated and adding technical advantages to existing devices used for spying but also for proposing a new headphone paradigm. Since the proposed earphones provide external environment information to the user by using the camera images (two near-infrared cameras that provide vision stereo capabilities) processed and sent 1201 in real time via Wi-Fi, combined with Bluetooth communication 1202 and audio features in a wireless way, they can also help to reduce the existing AR/VR goggle size by providing two extra cameras for hand tracking or other surrounding information of the user. Existing AR/VR goggles typically include several near-infrared cameras/Time-Of-Flight (TOF) sensors and stereo-pair visible-light cameras to understand users' hands and head movements and the environment and to track the user's hands and the surrounding 3D information in real time.

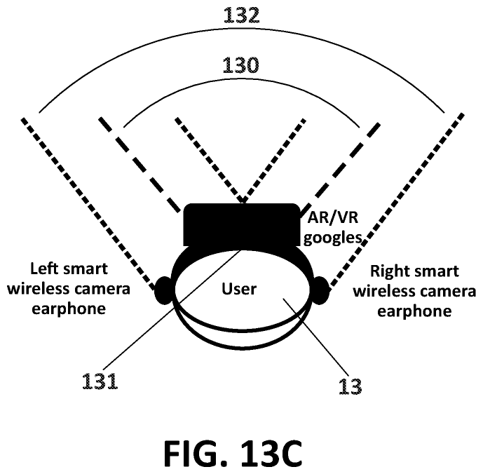

FIGS. 13A-13C are three graphic sketches to illustrate how the proposed wireless earphones increase the field of view in AR/VR/XR applications, depending on the mounted position of the near-infrared cameras and near-infrared LEDs in the earphones. FIG. 13A shows a top view of a user 13 wearing AR/VR/XR goggles 130 and the field of view 130 covered by the goggles 131 and the field of view 132 covered by the (left/right) earphones, in any of the aforementioned designs: in-ear earphones 100 and non-in-ear earphones 200. FIG. 13B shows a top view of the user 13 using the wireless earphones alone 133, without being linked to any AR/VR/XR headset, i.e., in a conventional configuration. Finally, FIG. 13C shows a top view of the user 13 wearing the AR/VR/XR goggles 131 and the wireless earphones which provide 3D information to the AR/VR AR/VR/XR goggles 130.

Note that in this text, the term “comprises” and its derivations (such as “comprising”, etc.) should not be understood in an excluding sense, that is, these terms should not be interpreted as excluding the possibility that what is described and defined may include further elements, steps, etc.

While example embodiments have been particularly shown and described, it will be understood by those skilled in the art that various changes in form and details may be made therein without departing from the scope of the embodiments encompassed by the appended claims.

What is claimed is:

1. A wireless earphone comprising:
an earbud casing;
a camera module located in the earbud casing, the camera module being configured to obtain images captured by at least one near-infrared camera and using at least one near-infrared light source, the at least one near-infrared camera and the at least one near-infrared light source being incorporated into the earbud casing;
a microcontroller located in the earbud casing, the microcontroller being configured to obtain information extracted from the captured images using computer vision and the microcontroller being communicated with at least one on-chip antenna located in the earbud casing to provide a Wi-Fi communication interface, and the microcontroller being further configured to send the captured images in real-time through the Wi-Fi communication interface;
a microphone and a speaker;
a Bluetooth module located in the earbud casing, configured to receive audio information and to play the received audio in the speaker.

2. The wireless earphone according to claim 1, wherein the microcontroller is a single multicore microcontroller with Wi-Fi and Bluetooth communication interfaces multiplexed onto one single on-chip antenna.

3. The wireless earphone according to claim 1, wherein the Bluetooth module comprises a Bluetooth microcontroller unit and a Bluetooth antenna, the Bluetooth microcontroller unit connected to both the microphone and the speaker, and the Bluetooth antenna connected to the Bluetooth microcontroller unit.

4. The wireless earphone according to claim 1, wherein the microcontroller is further configured to provide image processing of the captured images by using computer vision.

5. The wireless earphone according to claim 1, wherein the microcontroller is further configured to communicate, through the Wi-Fi communication interface, with an external guest device providing image processing by computer vision, to obtain at least part of the information extracted from the captured images.

6. The wireless earphone according to claim 1, wherein the microcontroller is further configured to communicate, through the Wi-Fi communication interface, with a headset for virtual reality and/or augmented reality applications, and further configured to send the obtained information from the images captured by the at least one near-infrared camera of the earphone to the headset.

7. The wireless earphone according to claim 1, wherein the speaker is attached to the earbud casing and the earphone is an in-ear earphone.

8. The wireless earphone according to claim 1, wherein the speaker is separated from the earbud casing and the earphone is a non in-ear earphone.

9. The wireless earphone according to claim 1, wherein the camera module is a mobile industry processor interface, MIPI, camera module.

10. The wireless earphone according to claim 1, wherein the near-infrared light source comprises at least one near-infrared light emitting diode.
